(19) United States
(12) Patent Application Publication
(10) Pub. No.: US 2022/0100830 A1
(43) Pub. Date: Mar. 31, 2022

(54) LOCK SYSTEM USING FIDO AUTHENTICATION

(71) Applicant: EWBM Co., Ltd., Seongnam-si (KR)

(72) Inventor: Stephen Sang Geun OH, Seoul (KR)

(73) Assignee: EWBM Co., Ltd., Seongnam-si (KR)

(21) Appl. No.: 17/293,675

(22) PCT Filed: Dec. 3, 2019
(86) PCT No.: PCT/KR2019/016912

§ 371 Date: Dec. 6, 2021

(30) Foreign Application Priority Data
Dec. 4, 2018 (KR) 10-2018-0154749

(51) Int. Cl. G06F 21/32; G07C 9/00

(52) U.S. Cl. CPC G06F 21/32; G07C 2009/00428; G07C 9/00309

(57) ABSTRACT

Disclosed is a lock system of a device by using FIDO authentication, the lock system including: an input terminal to which a biometric FIDO authenticator registered to a relying party on the cloud is inserted; an agent which receives an authentication message from the biometric FIDO authenticator and attempts FIDO authentication to a relying party when the biometric FIDO authenticator is inserted into the input terminal and biometric information of a user registered to the relying party is input to the biometric FIDO authenticator, and generates a lock releasing signal when an authentication response is received; and an operation control unit which releases a lock so that the device is operable when the lock releasing signal is received.

### TECHNICAL FIELD

The present invention relates to a lock system using FIDO authentication.

### BACKGROUND ART

In general, there are cases where a mechanical lock system provided in a device is provided in order to control a device, particularly, to control the right to access or the right to use the device. When a key is put in the mechanical lock system and turned, for example, a location or a shape of a protruding part is mechanically changed, so that, for example, a vehicle is started or opening/closing of a door is controlled. When the vehicle is started, the right to access or the right to use the vehicle is assigned, and when a door is opened, entrance is allowed, so that they can all be considered as unlocking the lock system.

Further, the mechanical lock system has been developed with various modifications by using electric and magnetic phenomenon. For example, there is a configuration in that when a button is simply pressed, the protruding part moves, so that the door is opened, but in general, intelligently, a configuration in which when a card or a key is inserted or is touched, opening/closing is electromagnetically controlled according to information within the card, a configuration in which when a password is input through a keypad, opening/closing is controlled according to the input information, and the like have been developed. Recently, there is a configuration in which opening/closing is controlled by using biometric information, such as fingerprints, irises, faces, veins, and voiceprint.

A patent document below discloses a vehicular door lock key assembly, including: a door keyset main body which is fixed to an outdoor panel of a vehicle, and includes a router formed with an insertion hole to which a key is inserted therein, and is provided so that the router is rotated while a plurality of lock plates is arranged by the insertion of the key to the insertion hole of the key; and a door lock rod, which has one end that is connected to a leading part of the router and the other end that is connected to a locking latch provided in the outdoor panel of the vehicle to transmit rotational force of the router to the locking latch while rotating in linkage with the rotation of the router, in which the door lock rod is separated into two so as to have different rotational axes between the router and the locking latch.

### PRIOR ART LITERATURE

### Patent Document

(Patent Document 1) Patent Application Laid-Open Gazette No. 10-2018-0060557

### DISCLOSURE

### Technical Problem

However, there is a case where one device is shared by a plurality of users. For example, there is a case where a drone education institution provides a plurality of students with a drone controller for a specific drone for use. In this case, it is necessary to exclusively assign the drone controller to a specific student at a specific time, and performance of the drone control by the student may be collected by a scoring device and used for grade evaluation.

In the related art, when lock of a device is controlled by using a card or a key, the device recognizes only the card or the key, so that when the card or the key is transferred to an unauthorized another person, there is a problem in that there is no way for the device to know the use of the device by another person even if another person uses the device. This is similarly applied to a keypad by a password, and when a password is given to an unauthorized another person, there is a problem in that there is no way for the device to know the input of the password by another person even if another person inputs the password to the keypad.

When the lock control is implemented by using biometric information, such as fingerprints, irises, face, veins, and voiceprint, the access and the use by a specific personnel are possible, but the biometric information of the specific personnel is stored in the device or the server, so that there are various problems in that the biometric information is exposed when the device is lost, hacking occurs when data is transmitted to the server for authentication, and the like.

The present invention is to solve the problem in the related art, and an object of the present invention is to provide a lock system using FIDO authentication, in which a biometric FIDO authenticator is inserted into an input terminal in the state where a lock system provided in a device is locked, and when biometric information of a user is input to the biometric

FIDO authenticator, an agent attempts FIDO authentication to a relying party on the Cloud, and when an authentication response is received, the lock is released.

### Technical Solution

In order to solve the object, the present invention provides a lock system of a device by using FIDO authentication, the lock system including: an input terminal to which a biometric FIDO authenticator registered to a relying party on the cloud is inserted; an agent which receives an authentication message from the biometric FIDO authenticator and attempts FIDO authentication to a relying party when the biometric FIDO authenticator is inserted into the input terminal and biometric information of a user registered to the relying party is input to the biometric FIDO authenticator, and generates a lock releasing signal when an authentication response is received; and an operation control unit which releases a lock so that the device is operable when the lock releasing signal is received.

When the biometric FIDO authenticator is separated from the input terminal, the agent may generate a lock signal, and the operation control unit may control the device to be locked so that the device is inoperable when the lock signal is received.

The lock system may further include a transmission unit which transmits an event at the time of the use of the device by the user to an external device based on the lock releasing signal.

The agent may be connected to the relying party via a LoRa network.

### Advantageous Effects

According to the present invention, there is provided the lock system using FIDO authentication, in which a biometric FIDO authenticator is inserted into an input terminal in the state where a lock system provided in a device is locked, and when biometric information of a user is input to the biometric FIDO authenticator, an agent attempts FIDO authentication to a relying party on the cloud, and when an authentication response is received, the lock is released.

### DESCRIPTION OF DRAWINGS

FIG. 1 is a block diagram illustrating an example of a lock system using FIDO authentication according to an exemplary embodiment of the present invention.

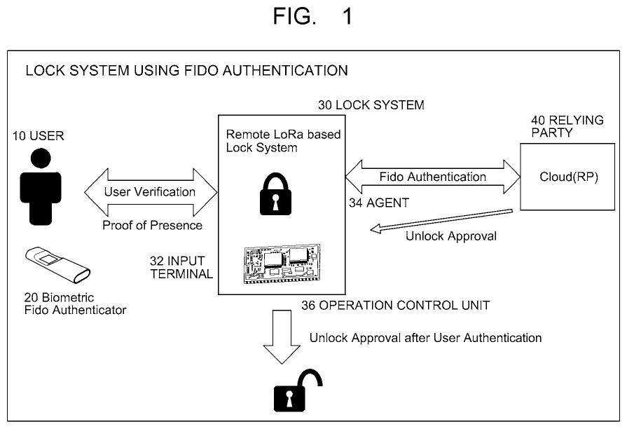

FIG. 2 is a block diagram illustrating an example of a device access control system using FIDO authentication according to an exemplary embodiment of the present invention, and illustrates a drone controller as an example of the device.

### BEST MODE

Hereinafter, an exemplary embodiment of the present disclosure will be described in detail with reference to the accompanying drawings. The advantages and characteristics of the present invention, and a method for achieving the advantages and characteristics will become clear by referring to the exemplary embodiment, which is described in detail, together with the accompanying drawings. However, the present disclosure is not limited to exemplary embodiments disclosed herein but will be implemented in various forms, and the exemplary embodiments are provided so that the present disclosure is completely disclosed, and a person of ordinary skilled in the art can fully understand the scope of the present disclosure, and the present disclosure will be defined only by the scope of the appended claims. Throughout the specification, the same reference numeral indicates the same constituent element.

Unless otherwise defined, all of the terms (including technical and scientific terms) used in the present specification may be used as a meaning commonly understandable by those skilled in the art. Further, terms defined in a generally used dictionary shall not be construed as being ideal or excessive in meaning unless they are clearly defined.

Further, the connection of a specific member or module to the front, rear, left, right, top, or bottom of another member or module may include not only a direct connection, but also a case where the specific member or module is connected to the front, rear, left, right, top, or bottom of another member or module with another third member or module interposed therebetween. Further, a member or module performing a specific function may be divided into and implemented with two or more members or modules by dividing the function, and on the contrary, two or more members or modules each having a function may be combined and implemented as one member or module by combining the functions. Further, a specific electronic functional block may be implemented by execution of software, and may also be implemented in the form in which the software is implemented in hardware through an electric circuit.

### Basic Configuration

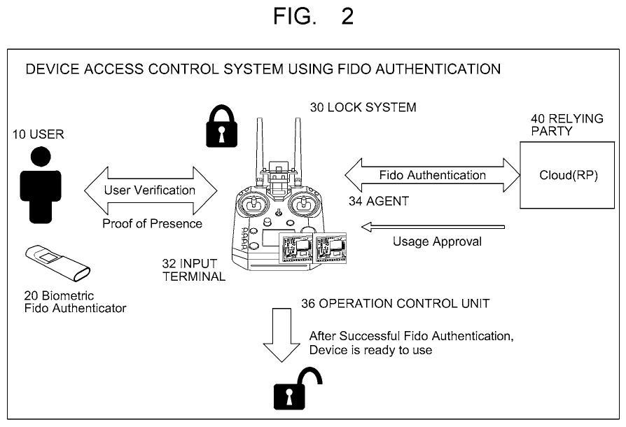

The present invention relates to a lock system 30 of a device (in FIG. 2, a drone controller is exemplified) using FIDO authentication. Lock and unlock of the device are the concepts including an operation control, the control of the right of use, the control of access of the device, as well as an entrance through a door.

The lock system 30 of the present invention includes an input terminal 32, an agent 34, and an operation control unit 36.

The input terminal 32 is the terminal that enables a biometric FIDO authenticator 20 registered in a relying party 40 on the Cloud to be inserted. Herein, the terminal is the concept of the connection interface, and is the concept including both wired and wireless.

For example, when the biometric FIDO authenticator 20 includes, for example, a USB interface, the input terminal also includes a corresponding USB interface corresponding to that of the biometric FIDO authenticator 20. For example, when the biometric FIDO authenticator 20 includes, for example, a Bluetooth interface, the input terminal also includes a Bluetooth interface corresponding to that of the biometric FIDO authenticator 20, and in this case, a physical terminal that appears externally may not exist.

Original biometric information of a user 10 is registered in the biometric FIDO authenticator 20 and user information and verification data for the original biometric information is registered in the relying party 40.

The agent 34 is a means for generating a lock signal or a lock releasing signal according to an authentication result, and may be formed of hardware or software. When the biometric FIDO authenticator 20 is inserted into the input terminal 32, and instantaneous biometric information of the user 10 registered in the relying party 40 is input to the biometric FIDO authenticator 20, the biometric FIDO authenticator 20 verifies the instantaneous biometric information by the original biometric information and outputs an authentication message when sameness is approved, and the agent 34 receives an authentication message from the biometric FIDO authenticator 20 and challenges the FIDO authentication to the relying party 40. The relying party 40 outputs an authentication response when the registered user information and the verification data for original biometric information are verified through the authentication message. As a result, the agent 34 generates the lock release signal when an authentication response is received.

The operation control unit 36 is the control element for releasing the lock, that is unlocking so that the device becomes operable when the lock releasing signal is received. The lock of the device may be achieved, for example, by disconnection of power supplied to an actuator such as a motor, by a mechanical brake on an operating part such as a control stick, or by disconnection of a signal transceiving unit such as an antenna. That is, locking is preventing the device from performing an original function of the device, and releasing the lock, that is, unlocking, is making the device recover a function of the device.

By the foregoing configuration, when the biometric FIDO authenticator 20 is inserted into the input terminal 32 and the instantaneous biometric information of the user 10 is input to the biometric FIDO authenticator 20, the agent 34 receives an authentication message from the biometric FIDO authenticator 20 and attempts FIDO authentication to the relying party 40 on the Cloud, and as a result, when the agent 34 receives an authentication response, the agent 34 generates a lock releasing signal and thus the operation control unit 36 releases the lock of the device.

Herein, only when the biometric FIDO authenticator 20 expected to be possessed by the rightful user 10 registered in the relying party is present in the input terminal 32 (proof of presence) and the right biometric information, such as the fingerprint, irises, face, vein, and voiceprint, of the user 10 is input to the biometric FIDO authenticator 20, the authentication message is transmitted from the biometric FIDO authenticator 20 to the agent 34 of the device at last. Accordingly, only when both the user 10 registered in the relying party and the biometric FIDO authenticator 20 are rightful, the authentication message is generated, thereby increasing a security level.

Further, only when the authentication message is verified by the relying party and the authentication response is generated, the lock is released (unlock), thereby increasing a security level.

<Performance of Lock>

Herein, when the biometric FIDO authenticator 20 is separated from the input terminal 32, the agent 34 generates a lock signal, and when the operation control unit 36 receives the lock signal, the operation control unit 36 may control the device to be locked so that the device is inoperable.

That is, in the state where the device is unlocked, when the biometric FIDO authenticator 20 is separated from the input terminal 32, the unlock state of the device is immediately switched to the lock state. Accordingly, it is possible to prevent illegal use of the device.

<External Transmission of Usage History>

Herein, the present invention may further include a transmission unit (not illustrated) which transmits an event at the time of the use of the device by the user 10 to an external device (not illustrated) based on the lock releasing signal.

For example, in the case of a drone education, the input terminal 32, the agent 34, and the operation control unit 36 are provided in the drone controller, and a wireless transmission unit is provided so as to permit (unlock) the use of the drone controller by the user 10 who is a specific student and transmit a drone operation history of the user 10 to a credit (score) server that is an external device, thereby promoting scientific credit (score) evaluation.

<Authentication Path>

For example, the agent 34 may be configured to be connected with the relying party 40 through a LoRa network.

The LoRa is one of the low-power wide-area networks, and has suitable performance for FIDO authentication because the LoRa can cover a distance of several tens of kilometers.

While the exemplary embodiment of the present invention has been described with reference to the accompanying drawings, and it will be understood by those skilled in the art that the present invention may be made in other specific forms without the change of the technical spirit or the essential features of the present invention. Therefore, it should be understood that the aforementioned exemplary embodiments are all illustrative and are not limited in all aspects.

### INDUSTRIAL APPLICABILITY

The present invention is usable to an industry of a lock system using FIDO authentication.

### EXPLANATION OF REFERENCE NUMERALS AND SYMBOLS

10: User

20: Biometric FIDO authenticator

30: Lock system

32: Input terminal

34: Agent

36: Operation control unit

40: Relying party

1. A lock system of a device by using FIDO authentication, the lock system comprising:
an input terminal to which a biometric FIDO authenticator registered to a relying party on the cloud is inserted;
an agent which receives an authentication message from the biometric FIDO authenticator and challenges FIDO authentication to a relying party when the biometric FIDO authenticator is inserted into the input terminal and biometric information of a user registered to the relying party is input to the biometric FIDO authenticator, and generates a lock releasing signal when an authentication response is received; and
an operation control unit which releases a lock so that the device is operable when the lock releasing signal is received.

2. The lock system of claim 1, wherein when the biometric FIDO authenticator is separated from the input terminal, the agent generates a lock signal, and
the operation control unit controls the device to be locked so that the device is inoperable when the lock signal is received.

3. The lock system of claim 1, further comprising:
a transmission unit which transmits an event at the time of the use of the device by the user to an external device based on the lock releasing signal.

4. The lock system of claim 1, wherein the agent is connected to the relying party via a LoRa network.
